(19) United States
(12) Patent Application Publication
(10) Pub. No.: US 2006/0115718 A1
(43) Pub. Date: Jun. 1, 2006

(54) Lithium ion polymer multi-cell and method of making

(75) Inventors: Mohammad Parsian, Swartz Creek, MI (US); Vesselin G. Manev, Flint, MI (US); Yee-Ho Chia, Troy, MI (US)

Correspondence Address: AKERMAN SENTERFITT, P.O. BOX 3188, WEST PALM BEACH, FL, 33402-3188, US

(73) Assignee: Delphi Technologies, Inc.

(21) Appl. No.: 11/000,277

(22) Filed: Nov. 30, 2004

(51) Int. Cl. H01M 10/04; H01M 6/46; H01M 2/14

(52) U.S. Cl. 429/152; 429/247; 29/623.3

(57) ABSTRACT

A lithium polymer battery or multi-cell and a method of making the multi-cells. The multi-cell comprises a plurality of laminated single cell units, each unit comprising, laminated in sequence, a negative electrode current collector, a negative electrode, a first electrolyte-impregnated separator, a positive electrode, and a positive electrode current collector. These single cell units are stacked one next to another in sequence and a second electrolyte-impregnated separator is positioned between adjacent laminated cell units. The method includes positioning, in sequence, a negative electrode current collector, a negative electrode, a first porous separator, a positive electrode, and a positive electrode current collector to form a single cell unit. A plurality of the single cell units are then positioned adjacent one another in sequence, and a second porous separator is positioned between adjacent single cell units. The method further includes impregnating each of the first and second porous separators with an electrolyte and laminating each single cell unit, but adjacent cell units are not laminated to one another.

### TECHNICAL FIELD

This invention relates to cell configurations for multi-cell lithium batteries, in particular lithium ion and lithium ion polymer battery cells, and a method of making multi-cells.

### BACKROUND OF THE INVENTION

Lithium ion cells and batteries are secondary (i.e., rechargeable) energy storage devices well known in the art. The lithium ion cell, known also as a rocking chair type lithium ion battery, typically comprises essentially a carbonaceous anode (negative electrode) that is capable of intercalating lithium ions, a lithium-retentive cathode (positive electrode) that is also capable of intercalating lithium ions, and a non-aqueous, lithium ion conducting electrolyte therebetween.

The carbon anode comprises any of the various types of carbon (e.g., graphite, coke, carbon fiber, etc.) which are capable of reversibly storing lithium species, and which are bonded to an electrochemically conductive current collector (e.g. copper foil or grid) by means of a suitable organic binder (e.g., polyvinylidene fluoride, PVdF). FIG. 1A depicts a typical anode structure 1 in which a negative electrode 20 is bonded to an external negative electrode current collector 10.

The cathode comprises such materials as transition metal chalcogenides that are bonded to an electrochemically conductive current collector (e.g., aluminum foil or grid) by a suitable organic binder. Chalcogenide compounds include oxides, sulfides, selenides, and tellurides of such metals as vanadium, titanium, chromium, copper, molybdenum, niobium, iron, nickel, cobalt and manganese. Lithiated transition metal oxides are at present the preferred positive electrode intercalation compounds. Examples of suitable cathode materials include LiMnO₂, LiCoO₂, LiNiO₂, and LiFePO₄, their solid solutions and/or their combination with other metal oxides and dopant elements, e.g., titanium, magnesium, aluminum, boron, etc. FIG. 1B depicts a typical cathode structure 3 in which a positive electrode 40 is bonded to an internal positive electrode current collector 50. As shown, the positive electrode current collector 50 splits the positive electrode 40 into two layers, one on either side of the current collector 50. It may be appreciated that, contrary to the structures shown in FIGS. 1A-1B, the anodes may comprise negative electrodes with internal current collectors, and the cathodes may comprise a positive electrode with an external positive electrode current collector.

The electrolyte in such lithium ion cells comprises a lithium salt dissolved in a non-aqueous solvent which may be (1) completely liquid, (2) an immobilized liquid (e.g., gelled or entrapped in a polymer matrix), or (3) a pure polymer. Known polymer matrices for entrapping the electrolyte include polyacrylates, polyurethanes, polydialkylsiloxanes, polymethacrylates, polyphosphazenes, polyethers, polyvinylidene fluoride, polyolefins such as polypropylene and polyethylene, and polycarbonates, and may be polymerized in situ in the presence of the electrolyte to trap the electrolyte therein as the polymerization occurs. Known polymers for pure polymer electrolyte systems include polyethylene oxide (PEO), polymethylene-polyethylene oxide (MPEO), or polyphosphazenes (PPE). Known lithium salts for this purpose include, for example, LiPF₆, LiClO₄, LiSCN, LiAlCl₄, LiBF₄, LiN(CF₃SO₂)₂, LiCF₃SO₃, LiC(SO₂CF₃)₃, LiO₃SCF₂CF₃, LiC₆F₅SO₃, LiO₂CF₃, LiAsF₆, and LiSbF₆. Known organic solvents for the lithium salts include, for example, alkylcarbonates (e.g., propylene carbonate, ethylene carbonate), dialkyl carbonates, cyclic ethers, cyclic esters, glymes, lactones, formates, esters, sulfones, nitrites, and oxazolidinones. The electrolyte is incorporated into pores in a separator layer between the cathode and anode. The separator may be glass mat, for example, containing a small percentage of a polymeric material, or may be any other suitable ceramic or ceramic/polymer material. Silica is a typical main component of the separator layer. The ion-conducting electrolyte provides ion transfer from one electrode to the other, and commonly permeates the porous structure of each of the electrodes and the separator.

Lithium and lithium ion polymer cells are often made by adhering, e.g., by laminating, thin films of the anode, cathode and/or the electrolyte-impregnated separator together. Each of these components is individually prepared, for example, by coating, extruding, or otherwise, from compositions including one or more binder materials and a plasticizer. The electrolyte-impregnated separator is adhered to an electrode (anode or cathode) to form a subassembly, or is adheringly sandwiched between the anode and cathode layers to form an individual cell or unicell. As depicted in FIG. 2, a single cell of a lithium battery includes a negative electrode 20 bonded to a negative electrode current collector 10 and a positive electrode 40 bonded to a positive electrode current collector 50, with an electrolyte-impregnated separator 30 interposed between the negative electrode 20 and positive electrode 40. A second electrolyte-impregnated separator and a second corresponding electrode may be adhered to form a bicell of, sequentially, a first counter electrode, a film separator, a central electrode, a film separator, and a second counter electrode. As shown in FIG. 3A, a pair of negative electrodes 20 each having an external negative electrode current collector 10 are adhered to a positive electrode 40 having an internal positive electrode current collector 50 where each negative electrode 20 is separated from the positive electrode 40 by a separator 30 containing the electrolyte. Thus, FIG. 3A depicts a laminated bicell having one positive electrode and two negative electrodes. A number of cells may be adhered and bundled together to form a high energy/voltage battery or multi-cell.

When the electrodes are ordered in sequence, but not laminated together, the electrodes are permitted to discharge from both sides. Cells with this design show very good discharge rate capability and specific power, but have a poor cycle life and a poor calendar life. When the cells are laminated at high temperature after formation, i.e., after the initial charging cycle, the cells show very good discharge rate capability and specific power, but again have poor cycle life and poor calendar life caused by cell chemistry deterioration during high temperature cell lamination with the electrolyte. In a bicell configuration, such as that shown in FIG. 3B, where each bicell includes a positive electrode laminated together with two negative electrodes (or vice versa) in a sandwich-like design and then stacked together to form a battery with N number of bicells, good cycle life and calendar life are achieved due to the lamination process, but only one side of the negative electrodes are used during the discharge process, thereby limiting applicability of the battery for high power or high discharge rate cell applications.

It is desirable to develop a battery cell configuration that allows each electrode to discharge uniformly from both sides to achieve high discharge rate and high power capability, while at the same time achieving long cycle life and calendar life.

### SUMMARY OF THE INVENTION

The present invention provides a lithium polymer battery or multi-cell comprising a plurality of laminated single cell units, each laminated single cell unit comprising a positive electrode adhered to a positive electrode current collector, a negative electrode adhered to a negative electrode current collector, and a first electrolyte-impregnated separator between the positive and negative electrodes. A second electrolyte-impregnated separator is positioned between adjacent laminated cell units. Each battery single cell unit may include two-layer electrode structures having the current collector positioned at an outer surface of the electrode, i.e., an external current collector, or three-layer electrode structures having the current collector sandwiched between two electrode layers or films, i.e., an internal current collector, or a combination of two- and three-layer electrode structures.

The present invention further provides a method of making a multi-cell for a lithium ion polymer battery. The method includes positioning, in sequence, a negative electrode current collector, a negative electrode, a first porous separator, a positive electrode, and a positive electrode current collector to form a single cell unit. A plurality of the single cell units are then positioned adjacent one another in sequence, and a second porous separator is positioned between adjacent single cell units. The method further includes impregnating each of the first and second porous separators with an electrolyte and laminating each single cell unit, but adjacent cell units are not laminated to one another.

### BRIEF DESCRIPTION OF THE DRAWINGS

The present invention will now be described, by way of example, with reference to the accompanying drawings, in which:

FIG. 1A is a negative electrode structure of the prior art.

FIG. 1B is a positive electrode structure of the prior art.

FIG. 2 is a unicell structure of the prior art.

FIG. 3A is a bicell structure of the prior art.

FIG. 3B is a multi-bicell structure of the prior art having N number of bicells.

FIG. 4A is a single cell structure according to one embodiment of the invention.

FIG. 4B is a multi-cell structure of the present invention including a plurality of the single cell structures of FIG. 4A.

FIG. 4C is a negative electrode structure for use in a multi-cell of the present invention.

FIG. 4D is a multi-cell according to an embodiment of the present invention, including a plurality of the single cell structures of FIG. 4A and a negative electrode structure of FIG. 4C.

FIG. 5A is a single cell structure in accordance with another embodiment of the present invention.

FIG. 5B is a multi-cell of the present invention, including a plurality of the single cell structures of FIG. 5A.

FIG. 5C is another multi-cell of the present invention, including a plurality of the single cell structures of FIG. 5A and a negative electrode structure of FIG. 1.

FIG. 5D is another multi-cell of the present invention.

### DETAILED DESCRIPTION

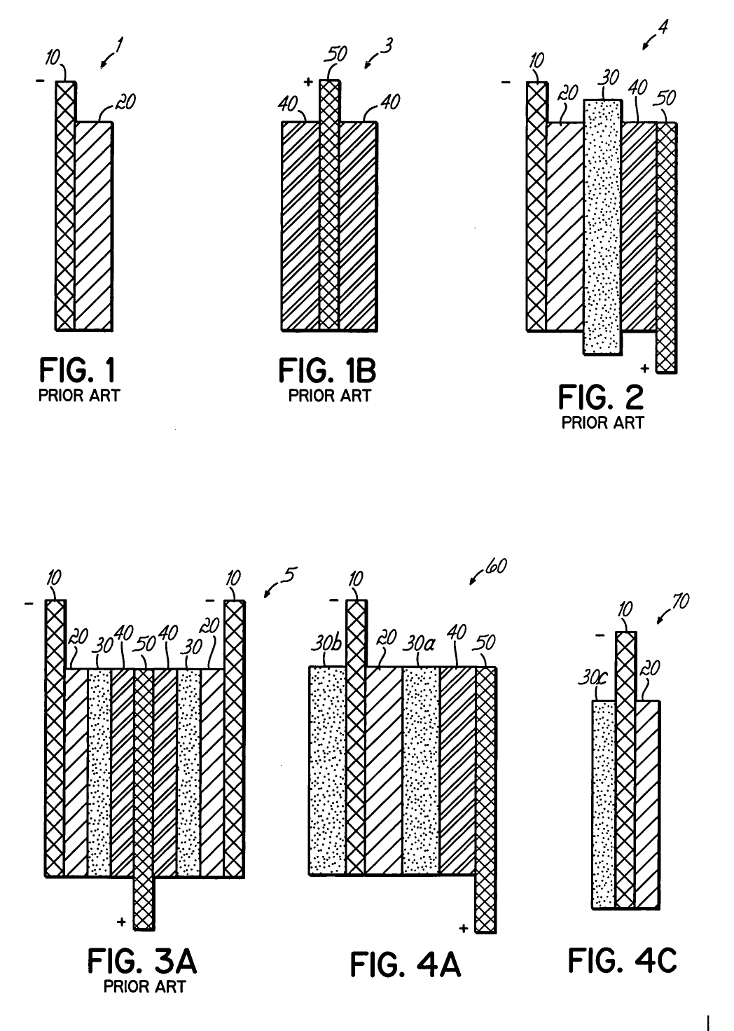

A battery multi-cell of the present invention comprises a plurality of laminated cell units, ordered in sequence. Each cell unit has a negative electrode (anode) adhered to a negative electrode current collector, a positive electrode (cathode) adhered to a positive electrode current collector, and a first electrolyte-impregnated separator between them. One or both electrode structures (the anode and/or the cathode) may comprise two or more electrode layers that are separated by an internal current collector. For example, an anode structure may be comprised of two negative electrode layers separated by a negative electrode current collector, and/or the cathode structure may be comprised of two positive electrode layers separated by a positive electrode current collector (as shown in FIG 1B). Alternatively, one or both electrode structures (the anode and/or the cathode) may comprise a single electrode layer and a current collector positioned external to the battery cell (as shown in FIGS. 1A and 2).

The electrodes, current collectors and first separator are adhered to form a laminated cell unit. As known to one skilled in the art, adherence may be accomplished by laminating using pressure (manual and/or mechanical), heat, or a combination of pressure and heat. A plurality of these laminated cell units are then ordered in sequence with a second electrolyte-impregnated separator therebetween. The adjacent laminated cell units are not laminated to each other, but merely separated by the second separator. The second separator may be adhered to an external surface of one of the adjacent cell units. In one embodiment of the present invention, the multi-cell comprises N cell units, N positive electrodes, and N negative electrodes. In another embodiment of the present invention, the multi-cell comprises N cell units, N positive electrodes, and N+1 negative electrodes. The number “N” may be any desired integer of 2 or greater, as appropriate for the application.

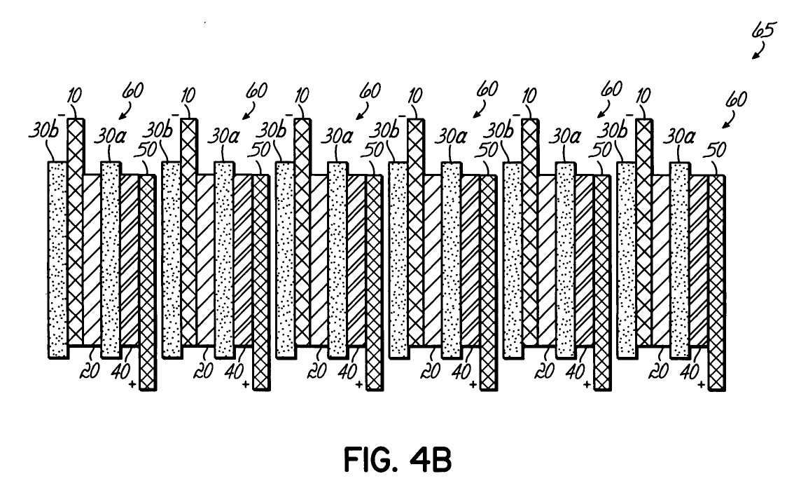

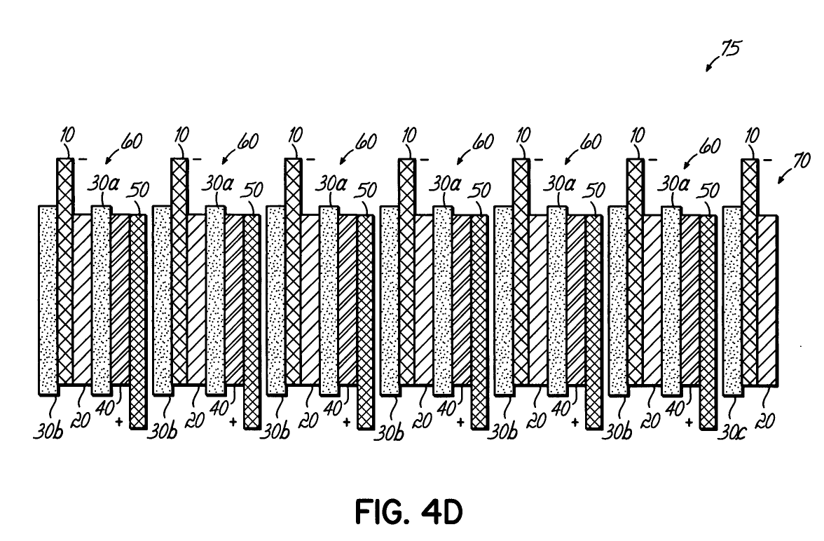

Referring now to the drawings, wherein like reference numerals designate identical or corresponding parts throughout the several views, FIG. 4A depicts in cross-section a single cell unit 60 according to an embodiment of the present invention. A negative electrode 20 is adhered to an external negative electrode current collector 10, a positive electrode 40 is adhered to an external positive electrode 50, and the positive electrode 40 and negative electrode 20 are laminated together with a first electrolyte-impregnated separator 30a therebetween. A second electrolyte-impregnated separator 30b is adhered externally to the negative electrode current collector 10. Thus, the single cell unit 60 comprises, in sequence, a second separator, a negative electrode current collector, a negative electrode, a first separator, a positive electrode, and a positive electrode current collector, all laminated together.

As shown in FIG. 4B, a multi-cell 65 of the present invention may then be formed by stacking together two or more of the single cell units 60 of FIG. 4A, in sequence. Thus, multi-cell 65 includes N single cell units 60, N positive electrodes 40, and N negative electrodes 20, with each negative electrode current collector 10/negative electrode 20 separated from a preceding positive electrode 40/positive electrode current collector 50 by the second separator 30b adhered to the negative electrode current collector 10. The second separator 30b is not laminated to the positive electrode current collector 50 of the preceding cell unit 60. In the particular embodiment shown in FIG. 4B, the multi-cell 65 includes 6 laminated single cell units 60, 6 negative electrodes 20, 6 positive electrodes 40, 6 first electrolyte-impregnated separators 30a, and 6 second electrolyte-impregnated separators 30b.

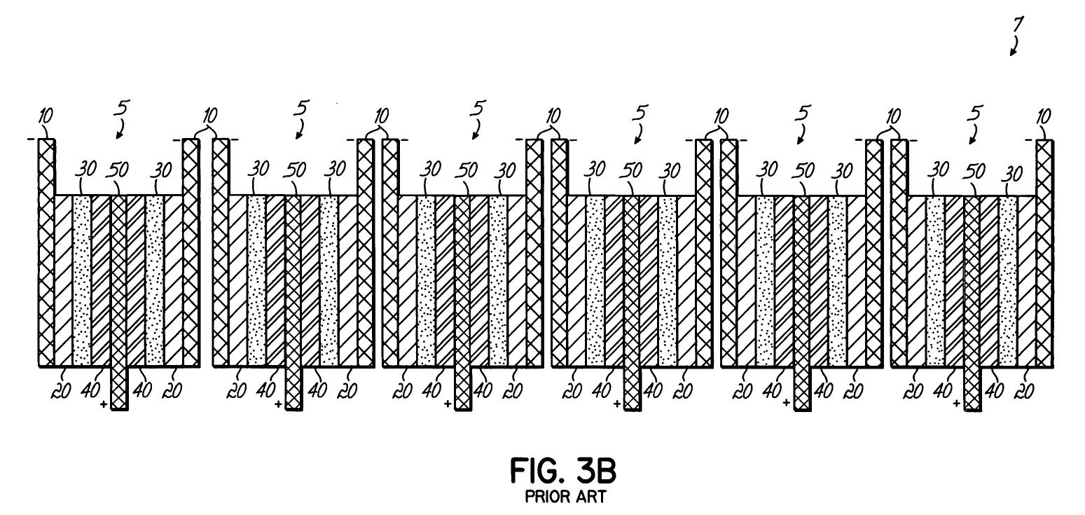

It may be appreciated that the first of the second electrolyte-impregnated separators 30b, on the left side of the multi-cell depicted in FIG. 4B, is unnecessary because there is no adjacent single cell unit, and thus may be eliminated without departing from the scope of the present invention. By this multi-cell design, both sides of each electrode are utilized during the discharge process to enable high discharge rate and high power capability, and the lamination used for each cell unit provides cell integrity, which in turn provides long cycling life and long calendar life. Referring back to the multi-bicell in FIG. 3B, the multi-bicell 7 includes 6 laminated bicell units 5, 12 negative electrodes 20, 6 split positive electrodes 40, and 12 first electrolyte-impregnated separators 30a. Multi-cell 65 of the present invention can achieve a higher discharge rate and higher power capability than multi-bicell 7, with half the negative electrodes.

For some applications, it may be desired to provide N+1 negative electrodes in the multi-cell. As depicted in FIG. 4C, a negative electrode unit 70 may be utilized in a multi-cell of the present invention. The negative electrode unit 70 includes the negative electrode 20 adhered to the negative electrode current collector 10 and a third electrolyte-impregnated separator 30c adhered to the negative electrode current collector 10. As depicted in FIG. 4D, the negative electrode unit 70 may be placed adjacent the last of the plurality of single cell units 60 in multi-cell 65 to create a new multi-cell structure 75 having N number of cell units, N positive electrodes, and N+1 negative electrodes. In the particular embodiment shown in FIG. 4D, the multi-cell 75 includes 6 laminated single cell units 60, 7 negative electrodes 20, 6 positive electrodes 40, 6 first electrolyte-impregnated separators 30a, and 7 second and third electrolyte-impregnated separators 30b, 30c.

In each of FIGS. 4A-4D, it may be appreciated that the second separator 30b need not be laminated to the negative electrode current collector 10 in cell unit 60, but rather, may be loosely positioned adjacent the negative electrode current collector 10, and thus, loosely stacked between single cell units (such as cell units 4 shown in FIG. 2) to achieve the same or similar effect. Also, it may be appreciated that the negative electrode 20 and external negative electrode current collector 10 may be replaced with a three-layer structure including two negative electrodes 20 sandwiching an internal negative electrode current collector 10. In FIG. 4A, the second separator 30b would then be adhered to the externally positioned negative electrode 20, or alternatively, loosely positioned adjacent thereto. Likewise, positive electrode 40 and external positive electrode current collector 50 may be replaced with a three-layer structure including two positive electrodes 40 sandwiching an internal positive electrode current collector 50, such as the three-layer structure depicted in FIG. 1B. Also, negative electrode unit 70 in FIG. 4C may comprise two negative electrodes 20 sandwiching an internal negative electrode current collector 10, and/or the third electrolyte-impregnated separator 30c need not be laminated, but rather, may be loosely positioned between the last single cell unit 60 and the negative electrode current collector 10.

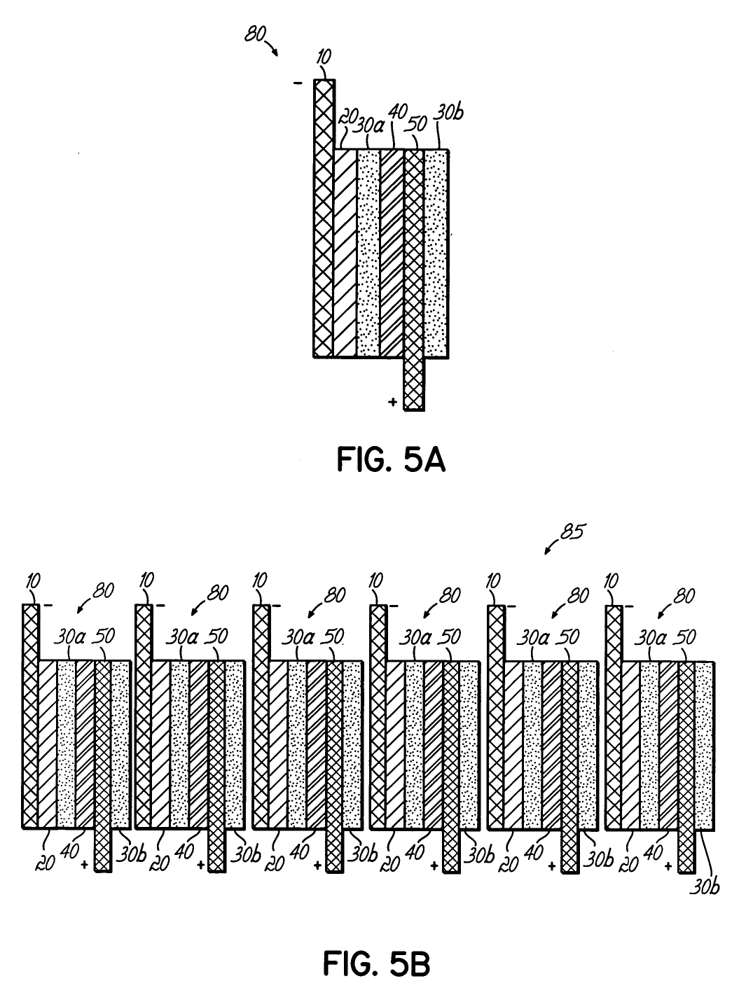

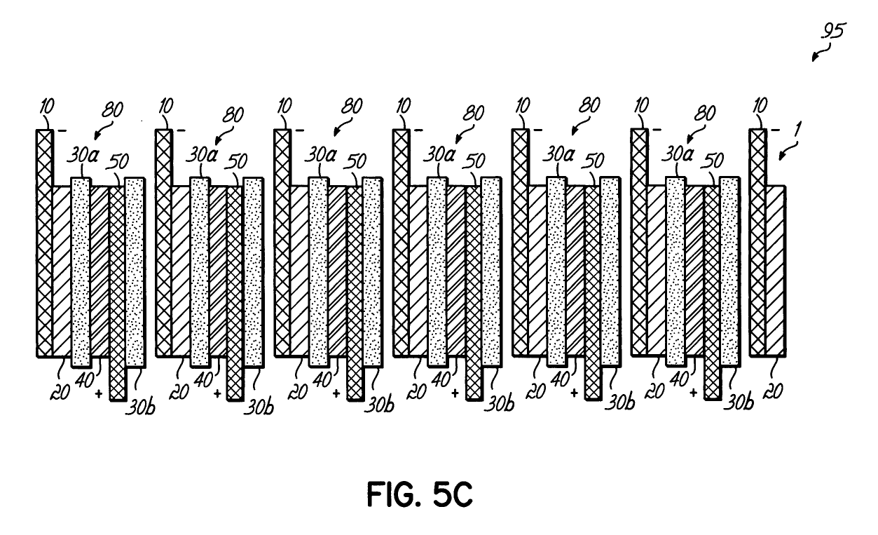

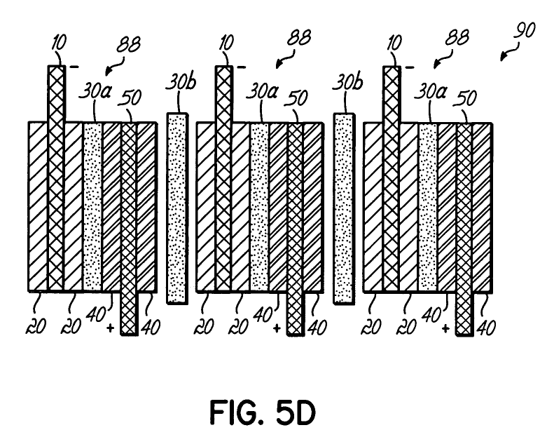

FIG. 5A depicts in cross-section another single cell unit 80 of the present invention, which is similar to the single cell unit 60 of FIG. 4A, but instead includes the second electrolyte-impregnated separator 30b adhered to the positive electrode current collector 50 rather than the negative electrode current collector 10. A plurality of these single cell units 80 stacked in sequence provide the multi-cell 85 depicted in FIG. 5B. The second separator 30b adhered to the positive electrode current collector 50 separates the positive electrode current collector 50 from the negative electrode current collector 10 of the adjacent cell unit 80. Multi-cell 85 includes N laminated single cell units, N positive electrodes, and N negative electrodes. More specifically, in the particular embodiment shown in FIG. 4B, the multi-cell 85 includes 6 laminated single cell units 80, 6 negative electrodes 20, 6 positive electrodes 40, 6 first electrolyte-impregnated separators 30a, and 6 second electrolyte-impregnated separators 30b. It may be appreciated that the last of the second electrolyte-impregnated separators 30b, on the right side of the multi-cell depicted in FIG. 5B, is unnecessary because there is no adjacent single cell unit, and thus may be eliminated without departing from the scope of the present invention.

As depicted in FIG. 5C, a negative electrode unit, such as electrode structure 1 depicted in FIG. 1A, may be added to the multi-cell structure 85 adjacent the last cell unit 80 to produce a multi-cell 95 having N laminated single cell units, N positive electrodes, and N+1 negative electrodes. In the particular embodiment shown in FIG. 5C, the multi-cell 95 includes 6 laminated single cell units 80, 7 negative electrodes 20, 6 positive electrodes 40, 6 first electrolyte-impregnated separators 30a, and 6 second electrolyte-impregnated separators 30b. Compared to multi-cell 75 in FIG. 4D, the design of multi-cell 95 includes one less electrolyte-impregnated separator, and more specifically, eliminates the need for the third electrolyte-impregnated separator 30c. As with the single cell unit and multi-cell structures depicted in FIGS. 4A-4D, the cell unit 80 and multi-cells 85 and 95 may include the second separator 30b loosely positioned adjacent the positive electrode current collector 50, rather than laminated thereto. Also similarly, the two-layer electrode/external current collector structures may be replaced with three-layer electrode/internal current collector/electrode structures.

As stated above, the second electrolyte-impregnated separator 30b may be loosely stacked between single cell units rather than being laminated to one of the electrodes or current collectors. In addition, each electrode/current collector structure may be three layers rather than two layers. These variations in accordance with the present invention are illustrated in cross section in FIG. 5D. Each single cell unit 88 comprises, laminated in sequence, a negative electrode 20, an internal negative electrode current collector 10, a negative electrode 20, a first electrolyte-impregnated separator 30a, a positive electrode 40, an internal positive electrode current collector 50, and a positive electrode 40. These single cell units 88 are stacked loosely together with a second electrolyte-impregnated separator 30b loosely positioned between adjacent cell units 88. Thus, in the particular embodiment shown, the multi-cell 90 includes 3 laminated single cell units 88, 3 split negative electrodes 20, 3 split positive electrodes 40, 3 first electrolyte-impregnated separators 30a, and 2 second electrolyte-impregnated separators 30b. This embodiment eliminates the unnecessary second electrolyte-impregnated separator 30b that exists at the end of the multi-cells 65 and 85 shown in FIGS. 4B and 5B.

Thus, in its broadest form, a lithium ion polymer multi-cell of the present invention comprises at least two cell units, each comprising a positive electrode laminated to a positive electrode current collector and a negative electrode laminated to a negative electrode current collector, where both electrodes are laminated together with a first electrolyte-impregnated separator therebetween, and wherein the cell units are separated from each other by a second electrolyte-impregnated separator in a manner such that the cell units are not laminated to each other. The second separator may be laminated to one of the adjacent cell units, or may be positioned loosely therebetween. Further, an additional negative electrode and negative electrode current collector may be added to the plurality of cell units.

In accordance with the present invention, the integrity of each cell unit may be achieved by lamination using a vacuum applied after cell activation, or after cell formation. Cell activation refers to the placement of an electrolyte solution into the porous portions of the cell unit. Formation refers to the initial charging of the battery cell by an external energy source prior to use. In another embodiment, cell integrity is achieved by lamination using capillary pressure of the electrolyte in the pores of the separators and electrodes. In yet another embodiment, cell integrity is achieved by lamination using light external pressure applied from opposite sides of the cell unit.

If desired, the second separator, which separates the laminated single cell units, may be of a different material than the first separator, which separates the electrodes within each single cell unit. Alternatively, the first and second separators may be equivalent in composition. Similarly, the third separator, if present, may be the same or different than the first and/or second separators.

The present invention further provides a method of making a multi-cell for a lithium ion polymer battery. The method includes positioning, in sequence, a negative electrode current collector 10, a negative electrode 20, a first porous separator 30a, a positive electrode 40, and a positive electrode current collector 50 to form a single cell unit. A plurality of the single cell units are then positioned adjacent one another in sequence, and a second porous separator 30b is positioned between adjacent single cell units. The method further includes impregnating each of the first and second porous separators with an electrolyte and laminating each single cell unit, but adjacent cell units are not laminated to one another. The second porous separators that are positioned between the adjacent single cell units may be loosely positioned therebetween or may be laminated to one of the current collectors, either the positive current collector of the preceding single cell unit, or the negative current collector of the subsequent single cell unit. The lamination of the single cell units may be performed before the single cell units are stacked together; after stacking but before activation, i.e., before impregnating the porous separators; or after impregnating, and either before or after battery cell formation, i.e., before or after the initial charging cycle.

While the present invention has been illustrated by the description of one or more embodiments thereof, and while the embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and method and illustrative examples shown and described. Accordingly, departures may be made from such details without departing from the scope of the general inventive concept.

What is claimed is:

1. A lithium ion polymer multi-cell, comprising:
a plurality of laminated single cell units positioned adjacent one another in sequence, each single cell unit comprising, laminated in sequence, a negative electrode current collector, a negative electrode, a first electrolyte-impregnated separator, a positive electrode, and a positive electrode current collector; and
a second electrolyte-impregnated separator interposed between each of adjacent single cell units such that none of the single cell units are laminated to an adjacent one of the single cell units.

2. The multi-cell of claim 1 wherein the second electrolyte-impregnated separator is laminated to the negative electrode current collector in each of the plurality of laminated single cell units.

3. The multi-cell of claim 2 further comprising a negative electrode unit positioned in sequence adjacent the plurality of laminated single cell units, the negative electrode unit comprising, laminated in sequence, a third electrolyte-impregnated separator, an additional negative electrode current collector, and an additional negative electrode.

4. The multi-cell of claim 1 further comprising a negative electrode unit positioned in sequence adjacent the plurality of laminated single cell units with a third electrolyte-impregnated separator therebetween, the negative electrode unit comprising an additional negative electrode current collector and an additional negative electrode.

5. The multi-cell of claim 1 wherein the second electrolyte-impregnated separator is laminated to the positive electrode current collector in each of the plurality of laminated single cell units.

6. The multi-cell of claim 5 further comprising a negative electrode unit positioned in sequence adjacent the plurality of laminated single cell units, the negative electrode unit comprising an additional negative electrode current collector laminated to an additional negative electrode.

7. The multi-cell of claim 1 further comprising a negative electrode unit positioned in sequence adjacent the plurality of laminated single cell units with a third electrolyte-impregnated separator therebetween, the negative electrode unit comprising an additional negative electrode current collector and an additional negative electrode.

8. The multi-cell of claim 1 wherein the first and second electrolyte-impregnated separators each comprise a porous separator material, and wherein the porous separator material of the first electrolyte-impregnated separator is different than the porous separator material of the second electrolyte-impregnated separator.

9. The multi-cell of claim 1 wherein the first and second electrolyte-impregnated separators each comprise a porous separator material, and wherein the porous separator material of the first electrolyte-impregnated separator is the same as the porous separator material of the second electrolyte-impregnated separator.

10. The multi-cell of claim 1 further comprising another negative electrode before the negative electrode current collector and another positive electrode after the positive electrode current collector whereby the negative and positive current collectors are each sandwiched between respective electrodes.

11. A method of making a multi-cell for a lithium ion polymer battery, comprising:
positioning, in sequence, a negative electrode current collector, a negative electrode, a first porous separator, a positive electrode, and a positive electrode current collector to form a single cell unit;
stacking a plurality of the single cell units adjacent one another in sequence;
positioning a second porous separator between adjacent single cell units;
laminating each single cell unit; and
impregnating each of the first and second porous separators with an electrolyte.

12. The method of claim 11 wherein the laminating is performed after the impregnating.

13. The method of claim 12 wherein the laminating includes applying a vacuum to each single cell unit.

14. The method of claim 12 wherein the laminating includes capillary pressure of the electrolyte in pores of the first and second porous separator and the positive and negative electrodes.

15. The method of claim 11 wherein the laminating includes applying light external pressure from opposing sides of each single cell unit.

16. The method of claim 11 further comprising forming the battery by charging the multi-cell using an external energy source, wherein the laminating is performed after the forming.

17. The method of claim 16 wherein the laminating includes applying a vacuum to each single cell unit.

18. The method of claim 11 further comprising laminating each second porous separator positioned between adjacent single cell units to one of the negative electrode current collector or the positive electrode current collector of one of the single cell units.

19. The method of claim 11 wherein the first and second porous separators comprise the same material.

20. The method of claim 11 wherein the first and second porous separators comprise a different material.
